(19) United States
(12) Patent Application Publication
(10) Pub. No.: US 2007/0164949 A1
(43) Pub. Date: Jul. 19, 2007

(54) Device and method for driving liquid crystal display

(75) Inventors: Wei-Kuo Lee, Hsinchu County (TW); Yi-Fan Chen, Taichung City (TW)

Correspondence Address: BIRCH STEWART KOLASCH & BIRCH, PO BOX 747, FALLS CHURCH, VA, 22040-0747, US

(73) Assignee: MSTAR SEMICONDUCTOR, INC.

(21) Appl. No.: 11/513,274

(22) Filed: Aug. 31, 2006

(30) Foreign Application Priority Data
Jan. 3, 2006 (TW) 095100124

(51) Int. Cl. G09G 3/36

(52) U.S. Cl. 345/87

(57) ABSTRACT

The present invention relates to a device and a method for driving a liquid crystal display. The device comprises: a luminance weighting value processor for calculating a luminance weighting value according to a luminance value of a current frame and a luminance value of a previous frame of the video signal; an overdrive value generator for generating an overdrive value according to the current frame and the previous frame of the video signal; an overdrive weighting value generator for generating an overdrive weighting value according to the luminance weighting value and the overdrive value; and outputting unit for applying the overdrive weighting value and the overdrive value to the current frame of the video signal. Using the device and the method for driving a liquid crystal display according to the present invention, noise due to overdriving can be reduced.

### BACKGROUND OF THE INVENTION

1. Field of the Invention

The present invention generally relates to a device and a method for driving a liquid crystal display and, more particularly, to a driving circuit and a driving method for overdriving a video signal in a liquid crystal display so as to eliminate image blur and improve the display quality.

2. Description of the Prior Art

The user communicates with an electronic device through messages processed by the display of the electronic device so as to make the most of the electronic device. The computer is an example of such an electronic device.

The liquid crystal display (LCD) is the most popular display due to its small size and lightness. The LCD pixels are arranged in an array and each of the pixels is provided with electrodes so that a voltage is applied to the liquid crystal molecules for controlling the alignment of the liquid crystal molecules that determines the transmissivity of light passing the liquid crystal molecules. Accordingly, a video signal can be displayed by way of controlling the alignment of liquid crystal molecules.

Please refer to FIG. 1, which is a timing diagram showing the relation between the pixel voltage and the transmissivity of light, where the solid line represents the pixel voltage and the dotted line L represents the transmissivity of light. Due to the slow response time of the liquid crystal molecules, when the pixel voltage in a liquid crystal display is switched from V1 to V2, the liquid crystal molecules can not turn to a pre-determined direction for achieving a pre-determined transmissivity of light within a frame time (T), resulting in image blur.

In order to overcome image blur, a method for overdriving liquid crystal molecules is used in a liquid crystal display. Please refer to FIG. 2, which is a timing diagram showing the relation between the pixel voltage and the transmissivity of light when a conventional method for overdriving liquid crystal molecules is used. When the pixel voltage in a liquid crystal display is switched from V1 to V2, the liquid crystal molecules are accelerated by applying a higher voltage V3 to turn to a pre-determined direction so as to achieve a pre-determined transmissivity of light within a frame time (T). The response time of a liquid crystal display replies on the twisting speed of liquid crystal molecules. The faster the twisting speed, the shorter the response time.

However, the aforesaid technology still has some drawbacks. For example, when the frame is switched from a low luminance value to a high luminance value (much higher than the low luminance value), noise associated with the great amount of signals overdriven increases as the frame signals are overdriven. This leads to degraded video quality, which requires to be improved.

Therefore, there is need in providing a device and a method for driving a liquid crystal display so as to improve the conventional technology for overdriving the video signal.

### SUMMARY OF THE INVENTION

It is one object of the present invention to provide a driving circuit for overdriving a video signal in a liquid crystal display, which takes a user-determined drivability into account and prevents the noise from increasing due to overdriving.

In order to achieve the foregoing object, the present invention provides a device for driving a liquid crystal display, the device comprising: a luminance weighting value processor for calculating a luminance weighting value according to a luminance value of a current frame of a video signal and a luminance value of a previous frame of the video signal; an overdrive value generator for generating an overdrive value according to the current frame and the previous frame of the video signal; an overdrive weighting value generator for generating an overdrive weighting value according to the luminance weighting value and the overdrive value; and an outputting unit for applying the overdrive weighting value and the overdrive value to the current frame of the video signal.

It is preferably that the device further comprises a luminance value calculator for calculating the luminance value of the video signal.

The present invention further provides a method for driving a liquid crystal display, the method comprising steps of: receiving a video signal; calculating a luminance weighting value according to a luminance value of a current frame and a luminance value of a previous frame of the video signal; generating an overdrive value according to the current frame and the previous frame of the video signal; generating an overdrive weighting value according to the luminance weighting value and the overdrive value; and applying the overdrive weighting value and the overdrive value to the current frame of the video signal.

### BRIEF DESCRIPTION OF THE DRAWINGS

The objects, spirits and advantages of the preferred embodiment of the present invention will be readily understood by the accompanying drawings and detailed descriptions, wherein:

FIG. 1 is a timing diagram showing the relation between the pixel voltage and the transmissivity of light for explaining the image blur phenomenon in a conventional liquid crystal display;

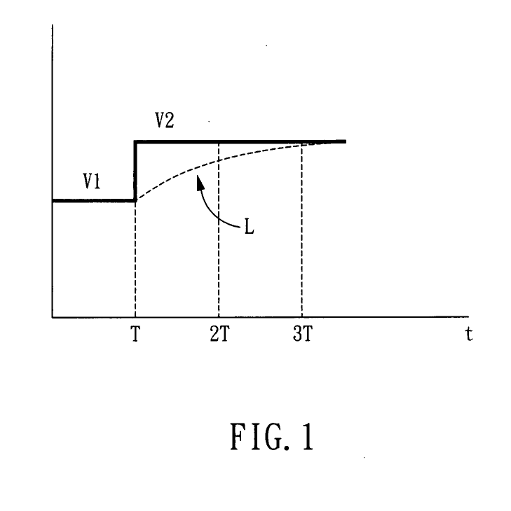

FIG. 2 is a timing diagram showing the relation between the pixel voltage and the transmissivity of light for eliminating the image blur phenomenon in a conventional liquid crystal display;

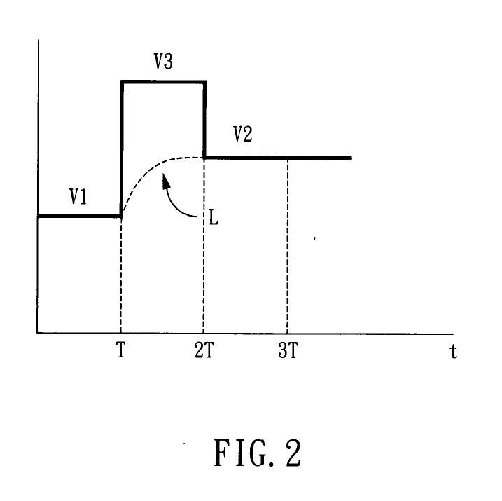

FIG. 3 is a functional block of a device for driving a liquid crystal display according to the present invention;

FIG. 4 is a functional block of an overdrive value generator of the device for driving a liquid crystal display according to the present invention; and

FIG. 5 is a flow-chart showing a method for driving a liquid crystal display according to the present invention.

### DETAILED DESCRIPTION OF THE PREFERRED EMBODIMENT

The present invention discloses a device and a method for overdriving a video signal in a liquid crystal display and can be exemplified by the preferred embodiment as described hereinafter.

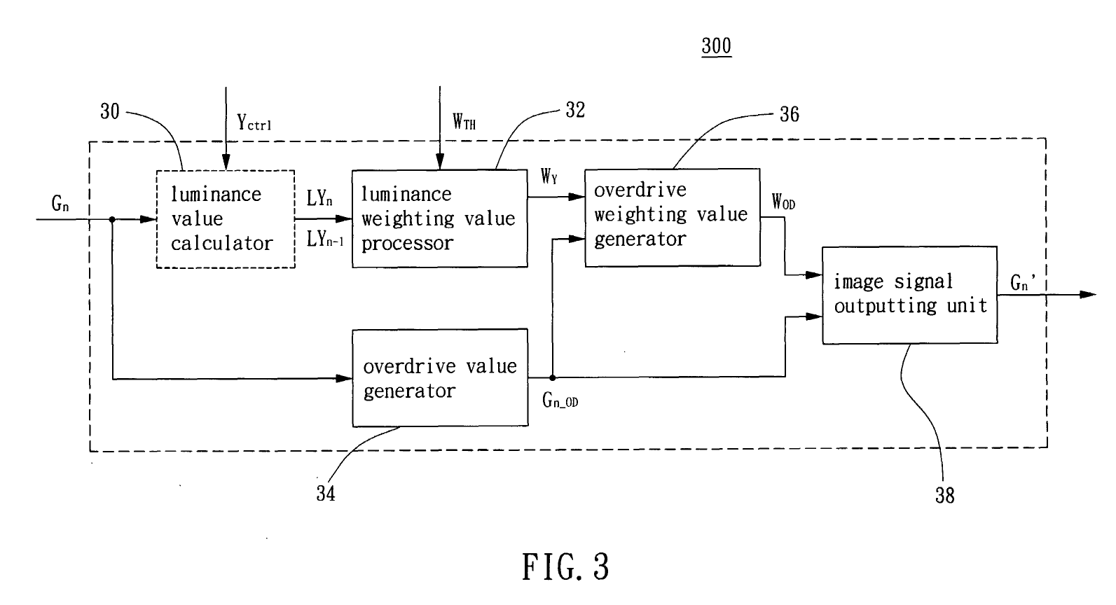

Functionally, the device for driving a liquid crystal display can be described with reference to the functional block shown in FIG. 3. The device 300 in FIG. 3 comprises a luminance weighting value processor 32, an overdrive value generator 34, an overdrive weighting value generator 36 and an outputting unit 38. In one embodiment, the device 300 of the present invention further comprises a luminance value calculator 30. The device 300 for driving a liquid crystal display receives a video signal Gₙ and applies a proper overdrive value to the video signal so as to output the video signal according to the comparison of a current frame and a previous frame of the video signal.

The luminance weighting value processor 32 calculates a luminance weighting value according to a luminance value LYₙ of a current frame Gₙ and a luminance value LYₙ₋₁ of a previous frame Gₙ₋₁ of the video signal. The luminance values LYₙ and LYₙ₋₁ can be obtained using the luminance value calculator 30. In one embodiment, the user adjusts the luminance values LYₙ and LYₙ₋₁ by inputting a control signal Y_{ctrl}. The luminance value LYₙ of the current frame Gₙ and the luminance value LYₙ₋₁ of the previous frame Gₙ₋₁ are input into the luminance weighting value processor 32 so as to obtain a luminance weighting value W_{Y}. In one embodiment, the luminance weighting value processor 32 is implemented using a look-up table (LUT). A corresponding luminance weighting value W_{Y} can be obtained using a pre-determined look-up table after the luminance value LYₙ of the current frame Gₙ and the luminance value LYₙ₋₁ of the previous frame Gₙ₋₁ are input into the luminance weighting value processor 32. Furthermore, a control signal W_{TH} is input by the user into the luminance weighting value processor 32 so as to adjust the luminance weighting value. More particularly, the control signal W_{TN} is a threshold signal in one embodiment so as to limit the luminance weighting value within a range. The control signal W_{TH} is used to prevent the noise from being amplified while the video signal is being overdrived.

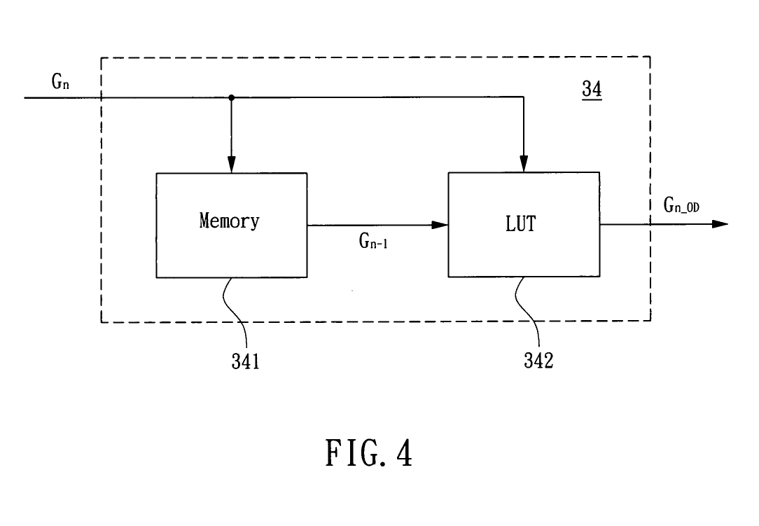

The overdrive value generator 34 generates an overdrive value to speed up the twisting of liquid crystal molecules. Please refer to FIG. 4, which is a functional block of an overdrive value generator 34 according to one embodiment of the present invention. The overdrive value generator 34 comprises a memory 31 for storing the video signal. After the current frame Gₙ of the video signal is input, the current frame Gₙ is stored in the memory 31 and then the current frame Gₙ and the previous frame Gₙ₋₁ are input into the look-up table 342 so as to obtain a pre-determined overdrive value Gₙ_{_{—}}_{OD}. The values stored in the look-up table 342 are pre-determined and stored in a memory. In another embodiment, a look-up table containing fewer values can be used with an interpolation circuit so as to obtain a proper overdrive value Gₙ_{_{—}}_{OD}, while reducing the memory capacity required for the look-up table.

In order to prevent the noise from being amplified while overdriving the video signal, the device 300 for driving a liquid crystal display according to the present invention comprises an overdrive weighting value generator 36 for generating an overdrive weighting value so as to limit and adjust the overdrive value and achieve noise reduction. The overdrive weighting value generator 36 generates a proper overdrive weighting value W_{OD} according to the luminance weighting value W_{Y} and the overdrive value Gₙ_{_{—}}_{OD}. Therefore, an overdrive weighting value W_{OD} for noise reduction is obtained based on the luminance and the overdrive value.

At last, the device 300 for driving a liquid crystal display according to the present invention comprises an outputting unit 38 for applying the overdrive value Gₙ_{_{—}}_{OD} and the overdrive weighting value W_{OD} to the current frame Gₙ of the video signal so as to obtain an output video signal Gₙ′. In one preferred embodiment, the output video signal Gₙ′ is expressed as:

Gₙ′=W_{OD}*Gₙ_{_{—}}_{OD}+(1−W_{OD})*Gₙ.

Therefore, with the output video signal Gₙ′, the present invention achieves overdriving liquid crystal molecules and noise reduction.

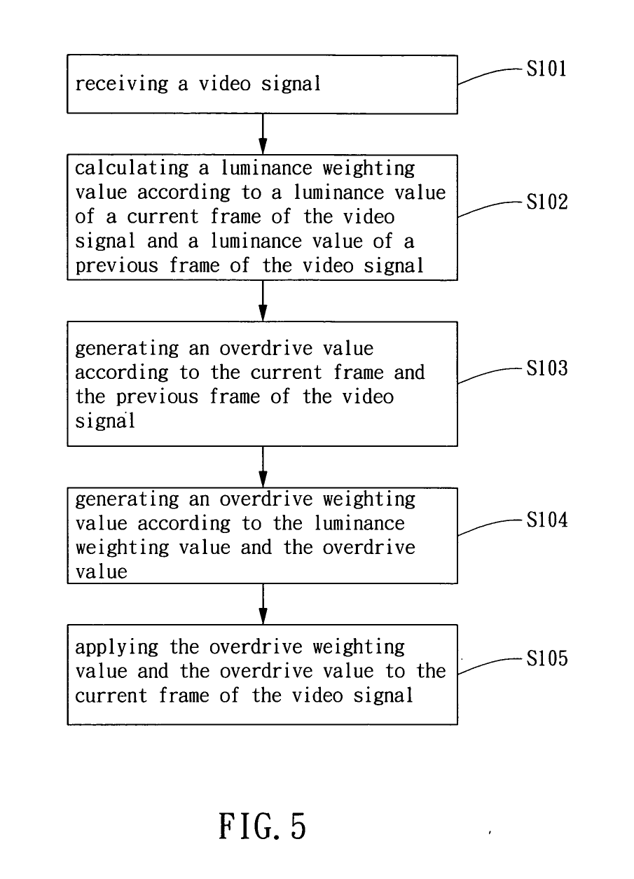

Please refer to FIG. 5, which is a flow-chart showing a method for driving a liquid crystal display according to the present invention. First, as described in Step S101, a video signal composed of continuous frames is received.

Then, in Step S102, a luminance weighting value is calculated according to a luminance value of a current frame and a luminance value of a previous frame in the continuous frames of the video signal. The luminance values of the input video signal are first calculated and a luminance weighting value is obtained based on the luminance value of the current frame and the luminance value of the previous frame of the video signal. The luminance weighting value is obtained using a pre-determined look-up table.

In Step S103, an overdrive value is generated according to the current frame and the previous frame of the video signal. In one embodiment, an overdrive value can be looked up in a pre-determined look-up table according to the video data of the current frame and the video data of the previous frame of the video signal. However, in another embodiment, a look-up table containing fewer values can be used with interpolation so as to obtain a proper overdrive value, while reducing the memory capacity required for the look-up table.

In Step S104, an overdrive weighting value is generated according to the luminance weighting value and the overdrive value. In order to prevent the noise from being amplified while overdriving the video signal, the present invention uses an overdrive weighting value so as to limit and adjust the overdrive value and achieve noise reduction. The overdrive weighting value is obtained based on the luminance and the overdrive value.

Finally, in Step S105, the overdrive weighting value and the overdrive value are applied to the current frame of the video signal and the video signal is output. The overdrive weighting value and the overdrive value are applied to the current frame of the video signal so that the video signal is overdrived to eliminate image blur and the noise due to overdrive can be prevented by the overdrive weighting value.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A device for driving a liquid crystal display, the device comprising:
a luminance weighting value processor for calculating a luminance weighting value according to a luminance value of a current frame of a video signal and a luminance value of a previous frame of the video signal;
an overdrive value generator for generating an overdrive value according to the current frame and the previous frame of the video signal;
an overdrive weighting value generator for generating an overdrive weighting value according to the luminance weighting value and the overdrive value; and
an outputting unit for applying the overdrive weighting value and the overdrive value to the current frame of the video signal.

2. The device as recited in claim 1, further comprising a luminance value calculator for calculating the luminance value of the video signal.

3. The device as recited in claim 2, wherein the luminance value calculator receives a control parameter for adjusting the luminance value of the video signal.

4. The device as recited in claim 1, wherein the luminance weighting value processor receives a control signal for controlling a threshold for the luminance weighting value.

5. The device as recited in claim 1, wherein the overdrive value generator comprises a first look-up table (LUT) for generating the overdrive value.

6. The device as recited in claim 5, wherein the first look-up table is stored in a first memory.

7. The device as recited in claim 6, wherein the overdrive value generator comprises an interpolation circuit.

8. The device as recited in claim 1, wherein the previous frame of the video signal is stored in a second memory.

9. The device as recited in claim 1, wherein the luminance weighting value processor comprises a second look-up table (LUT) for looking up the luminance weighting value.

10. A method for driving a liquid crystal display, the method comprising steps of:
receiving a video signal;
calculating a luminance weighting value according to a luminance value of a current frame of the video signal and a luminance value of a previous frame of the video signal;
generating an overdrive value according to the current frame and the previous frame of the video signal;
generating an overdrive weighting value according to the luminance weighting value and the overdrive value; and
applying the overdrive weighting value and the overdrive value to the current frame of the video signal.

11. The method as recited in claim 10, further comprising a step of:
calculating the luminance value of the video signal.

12. The method as recited in claim 10, wherein the overdrive value is generated using a look-up table (LUT).

13. The method as recited in claim 10, wherein the overdrive value is generated using a look-up table (LUT) and interpolation.
